(19) United States
(12) Patent Application Publication
(10) Pub. No.: US 2025/0376039 A1
(43) Pub. Date: Dec. 11, 2025

(54) HYDRAULIC SYSTEM FOR A DYNAMIC ENERGY TRANSFER SYSTEM INCLUDING HYDRAULIC ASSIST

(71) Applicant: Caterpillar Inc., Peoria, IL (US)

(72) Inventors: Steven E. JOHNSON, Metamora, IL (US); Dennis D. RANKIN, Oro Valley, AZ (US); Maitreya V. LAGADAPATI, Joliet, IL (US); Darshan C. PATEL, Des Plaines, IL (US)

(73) Assignee: Caterpillar Inc., Peoria, IL (US)

(21) Appl. No.: 19/218,828

(22) Filed: May 27, 2025

Related U.S. Application Data
(60) Provisional application No. 63/657,677, filed on Jun. 7, 2024.

(51) Int. Cl. B60L 5/38

(52) U.S. Cl. CPC B60L 5/38; B60L 2200/40

(57) ABSTRACT

A method and system are provided for deploying a rail connector assembly of a mobile machine onto one or more conductor rails. The rail connector assembly includes a boom assembly connected to a frame of the machine, an arm assembly connected to an end of the boom assembly, and a contactor assembly coupled to an end of the arm assembly. The method includes deploying the boom assembly from a stowed condition to a deployed condition with at least one boom assembly hydraulic actuator, deploying the arm assembly from a stowed condition to a deployed condition with at least one arm assembly hydraulic actuator, and providing hydraulic assist to the at least one arm assembly hydraulic actuator, as a function of a contact relationship of the contactor assembly with one or more conductor rails.

### CROSS-REFERENCE TO RELATED APPLICATION

This application claims the benefit of priority to U.S. Provisional Patent Application No. 63/657,677, filed on Jun. 7, 2024, the entirety of which is incorporated herein by reference.

### TECHNICAL FIELD

The present disclosure relates generally to a dynamic energy transfer system for a mobile machine and, more specifically, to a hydraulic system for controlling a rail connector assembly of a dynamic energy transfer system.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments. Other problems include the ability to safely deliver electricity to a moving industrial vehicle. It is therefore beneficial for industrial machines to have control systems with the ability to quickly deploy or retract a connector assembly, either manually or automatically, with minimal, if any, assistance from the machine operator.

An electric delivery system for providing electric power to a traveling vehicle is described in International Patent App. Pub. No. WO 2020/186296 A1, published on Sep. 24, 2020 (“the '296 publication”). The system described in the '296 publication describes an electrical delivery system at a mine site for a moving vehicle where two conductors are anchored to relocatable roadside barriers. In order to charge the moving vehicle, the delivery system requires a retractable arm to precisely engage with electrical connectors embedded within a horizontal channel of the roadside barriers. While the system described in the '296 publication may be helpful in some circumstances, the '296 publication does not describe, among other things, a system to easily maintain the connection between the electrical delivery system to the roadside electrical conductors while the mobile industrial machines is moving.

Aspects of the present disclosure may solve one or more of the problems set forth above and/or other problems in the art. The scope of the current disclosure, however, is defined by the attached claims, and not by the ability to solve any specific problem.

### SUMMARY

According to one aspect of the disclosure, a method is provided for deploying a rail connector assembly of a mobile machine onto one or more conductor rails. The rail connector assembly includes a boom assembly connected to a frame of the machine, an arm assembly connected to an end of the boom assembly, and a contactor assembly coupled to an end of the arm assembly. The method includes deploying the boom assembly from a stowed condition to a deployed condition with at least one boom assembly hydraulic actuator, deploying the arm assembly from a stowed condition to a deployed condition with at least one arm assembly hydraulic actuator, and providing hydraulic assist to the at least one arm assembly hydraulic actuator, as a function of a contact relationship of the contactor assembly with one or more conductor rails.

According to another aspect of the disclosure, a method is provided for deploying a rail connector assembly of a mobile machine onto one or more conductor rails. The rail connector assembly includes a boom assembly connected to a frame of the machine, an arm assembly connected to an end of the boom assembly, and a contactor assembly coupled to an end of the arm assembly. The method includes deploying the boom assembly from a stowed condition to a deployed condition with at least one boom assembly hydraulic actuator, deploying the arm assembly from a stowed condition to a deployed condition with at least one arm assembly hydraulic actuator, placing at least one arm assembly hydraulic actuator in a float condition and simultaneously providing hydraulic lift assist to the at least one arm assembly hydraulic actuator when the contactor assembly is riding on the one or more conductor rails.

According to yet another aspect, a rail connector assembly for an electrically powered mobile machine includes a boom assembly with a first end and a second end, an arm assembly movable between a stowed condition and a deployed condition, the arm assembly having a first end coupled to the boom, and a second end, and a contactor assembly coupled to the second end of the arm assembly. The rail connector assembly also includes a hydraulic system including a float and lift assist valve system associated with the arm assembly.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electrically-powered mobile machine including a rail connector assembly for coupling with a conductive rail system, according to aspects of the present disclosure.

FIG. 2 is a perspective view of a boom assembly of the rail connector assembly of FIG. 1.

FIG. 3 is a perspective view of an arm assembly and contactor assembly of the rail connector assembly of FIG. 1.

FIG. 4 is a schematic of a hydraulic system for operating a rail connector assembly.

FIG. 5 is a flowchart illustrating an exemplary method for controlling the rail connector assembly and hydraulic system of FIG. 4.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

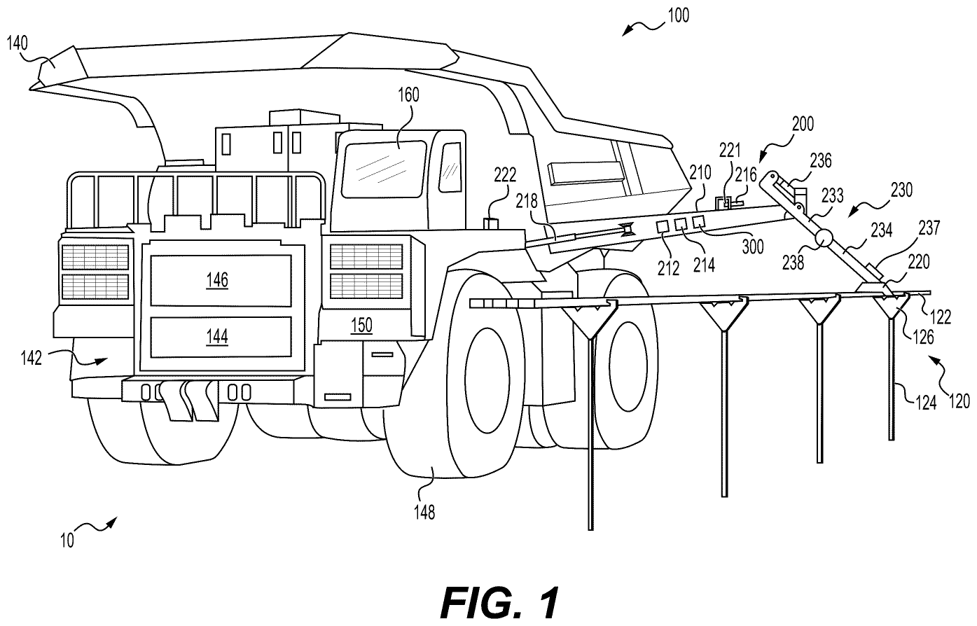

FIG. 1 depicts a mobile machine power system 100 including an electrically-powered mobile machine 140 having an electricity-conducting rail connector assembly 200, and an electricity-conducting rail system 120 for providing electric power to the mobile machine 140. As used herein, the phrase “electrically-powered” includes machine systems that are entirely electric as well as hybrid machine systems. In a hybrid machine, an internal combustion engine is included to assist with propulsion and/or generation of electric power. An internal combustion engine is omitted in an entirely or all-electric machine.

The mobile machine 140 includes an electric drive system 142 having at least one electric motor 144, and may include at least one battery system 146. The electric drive system 142 drives a set of ground-engaging elements 148, such as tires or continuous tracks, for propelling and maneuvering the mobile machine 140 over the ground 10. The mobile machine 140 also includes a frame/body 150 that supports the mobile machine's mechanical components, including the electricity-conducting rail connector assembly 200. As noted above, mobile machine 140 may include either a hybrid or an all-electric power system, and the electricity-conducting rail system 120 may be applied to either system. Mobile machine 140 and its various systems may be controlled via a machine operator located in the operator cabin 160, and/or mobile machine 140 may be semi- or fully-autonomous or remotely operated.

The mobile machine 140 is free-steering, allowing the operator of the machine (or autonomous control system) to freely control the direction and route of the machine. Thus, the exemplary mobile machine 140 is configured to travel (e.g., in a free-steering manner) selectively along a work route or path within a job site, with the electricity-conducting rail system 120 positioned generally along the route or path. The mobile machine 140 of FIG. 1 is shown in the context of a mining truck which is commonly used for transporting ore in a mine environment. The present disclosure is not so limited, however, and other types of machines are within the scope of the present disclosure, including articulated trucks, asphalt pavers, backhoe loaders, drills, rope shovels, excavators, forest machines, hydraulic mining shovels, material handlers, motor graders, off-highway trucks, pipelayers, road reclaimers, telehandlers, track loaders, underground mining dump loaders and trucks, wheel loaders, wheel tractor-scrapers, or other machines.

The electricity-conducting rail system 120 includes a plurality of elevated conductor rails 122 connected to a power source (e.g., a power grid, generator, and/or energy storage devices, not shown). The conductor rails 122 may be supported by a plurality of ground-engaging support poles 124 and rail bracket assemblies 126. While FIG. 1 shows an example where the plurality of conductor rails 122 contains three conductor rails, the plurality of conductor rails 122 may contain fewer or more rails. In this example, two of the conductor rails provide electrical power at different polarities (e.g., a conductor rail with a positive polarity and a conductor rail with a negative polarity) while the third conductor rail provides a reference of 0 volts (ground). The elevated conductor rails 122 may have a height, for example, in the range of 8 to 15 feet above the ground 10. Thus, the electricity-conducting rail system does not form a pantograph-type overhead power system, nor an under-machine or low-ground-located power system.

The electricity-conducting rail connector assembly 200 electrically connects the mobile machine 140 to the electricity-conducting rail system 120. The electricity-conducting rail connector assembly 200 includes a boom assembly 210 having a proximal end and a distal end; an arm assembly 230, such as a trailing arm assembly, having a first or proximal end connected to the distal end of the boom assembly 210; and a contactor assembly 220 connected to a second or distal end of the arm assembly 230. As used herein, the term “trailing” refers to a direction opposite the forward direction of travel of the mobile machine 140. The contactor assembly 220 is configured to interface with the electricity-conducting rail system 120 through a plurality of conductor terminals.

The rail connector assembly 200 houses, for example, an electricity-conveying system 212, an electronics system 214, and a hydraulic system 300. Electricity-conveying system 212 may include, for example, various busbars, electrical cables, electrical joints, contactors, brushes, etc. Electronics system 214 may include, for example, an electronic control module (“ECM”), a plurality of sensors, a plurality of electronic actuators, etc. Hydraulic system 300 may include a hydraulic circuit including a hydraulic power unit, hydraulic lines, linear and/or rotary hydraulic actuators, etc., which will be described in more detail below. While electricity-conveying system 212, electronics system 214, and hydraulic system 300 are disclosed as being self-contained on or within rail connector assembly 200 to assist in adding rail connector assembly 200 to existing machine designs, it is understood that various components of these systems could be located on the frame/body 150 of the mobile machine 140. Such frame-located components could include, for example, the hydraulic power unit.

Hydraulic system 300 may be configured for pivotably extending, retracting, and locking the boom assembly 210, arm assembly 230, and connector assembly 220. The ECM may be housed within the boom assembly 210 and receive signals from the mobile machine 140 and the sensors within the rail connector assembly 200 to generate commands to the various components of the rail connector assembly 200. For example, in the case of controlling the hydraulic system 300, the ECM may monitor various component and generate and send actuation commands (e.g., electronic signals) to the various components of the hydraulic system 300. In some embodiments, the rail connector assembly 200 may additionally include a pneumatic system for generating and controlling one or more pneumatic actuators for controlling aspects of rail connector assembly 200. While the disclosure below will provide details of hydraulic system 300, it is understood that certain components and features may be controlled by a pneumatic system.

As shown in FIG. 1 the boom assembly 210 extends generally horizontally from a side of the mobile machine and is connected to a side of the frame/body 150 of the mobile machine 140 about a pivot joint. The pivot joint is located at a height of over 8 feet on the machine (above the ground 10). While the boom assembly 210 is shown attached to a large mining truck, the same boom assembly 210 is capable of being incorporated onto various types of mobile machines 140 by use of an interchangeable adapter (not shown) that is specific to the type of machine being operated.

As previously referenced, the electricity-conducting rail connector assembly 200 includes several different states of deployment, including an extended or deployed state in which the boom assembly 210 is extended generally horizontally outward away from a side of the mobile machine 140 (as shown in FIG. 1), a retracted or stowed state (not shown) in which the boom assembly 210 is rotated or pivoted inward to rest against the frame/body 150 of the mobile machine, and a locked state in which the boom assembly is locked to the side of the machine frame/body 150 in the retracted or stowed state. Movement of the rail connector assembly 200 may be achieved by a plurality of actuators, such as, for example a boom actuator 218, a boom lock actuator 216, an upper trailing arm actuator 236, a middle trailing arm actuator 238, and a lower trailing arm actuator 237. All of these actuators may be part of hydraulic system 300, as will be explained in more detail below. Boom actuator 218 may include a hydraulic actuator, such as a liner hydraulic actuator, coupled between the frame/body 150 of mobile machine 140, and a location along a length of boom assembly 210. Boom lock actuator 216 may include a linear actuator located, for example, on a top surface of the boom assembly 210. The boom lock actuator 216 may be actuated to move a locking pin 221 into and out of locking engagement with a lock receiver 222 located on the frame/body 150.

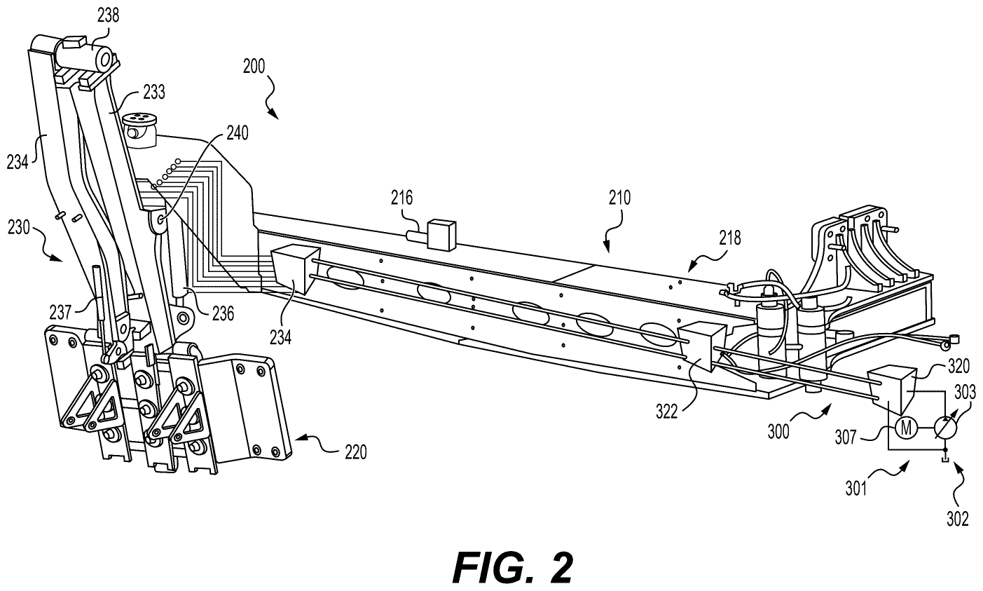

FIG. 2 depicts the rail connector assembly 200 in a stowed and locked position, along with portions of hydraulic system 300. In the stowed and locked position, the boom assembly 210 is positioned against a side of the frame/body 150, such that boom assembly 210 extends generally parallel and adjacent to the side of the mobile machine 140. Further, in this stowed and locked state, the arm assembly 230 may be positioned such that upper and lower arms 233 and 234 folded against one another and the contactor assembly is magnetically coupled to a portion of upper arm 233.

As shown, the hydraulic system 300 may generally include a hydraulic power unit (HPU) 301, the various hydraulic actuators (216, 218, 238, 236, 237) associated with rail connector assembly 200, and a plurality of serially connected valve manifolds 320, 322, and 324 for controlling hydraulic fluid to and from the boom assembly 210 and the various actuators. The components of the hydraulic system 300 may be located within the rail connector assembly 200 or in the mobile machine 140 (the “machine side”). For example, the HPU 301, and a machine side valve manifold 320 may be located on the mobile machine 140, and not on the rail connector assembly 200, and a boom valve manifold 322 and arm and contactor valve manifold 324 may both be located within the boom assembly 210.

The HPU 301 may be used for other hydraulic systems and components of the mobile machine 140, and may include, for example, a high voltage electric motor 307 driving a pump 303, such as a variable displacement cut-off pump, a fluid reservoir or tank 302, and other appropriate components. HPU 301 may be configured to help ensure the delivery and maintenance of pressure in the hydraulic system 300, including providing pressurized hydraulic fluid to the plurality of hydraulic actuators (216, 218, 236, 237, 238). Together, the components that comprise the HPU 301 deliver pressurized fluid to the hydraulic manifold 320 through one or more hydraulic lines. The rail connector assembly 200 may include a boom valve manifold 322 for providing controlled hydraulic fluid to the systems associated with boom actuator 218 and boom lock actuator 216. The boom valve manifold 322 may be located within a proximal end of the boom assembly 210, such as in a proximal first quarter of the boom length. This close proximity to the proximal end of the boom assembly 210 may reduce undesirable moment forces and line pressure drops. An arm and contactor valve manifold 324 may provide controlled hydraulic fluid to the arm assembly 230 and contactor assembly 220. Arm and contactor valve manifold 324 may be located within the distal end of the boom assembly 210, such as in a distal third quarter of the boom length.

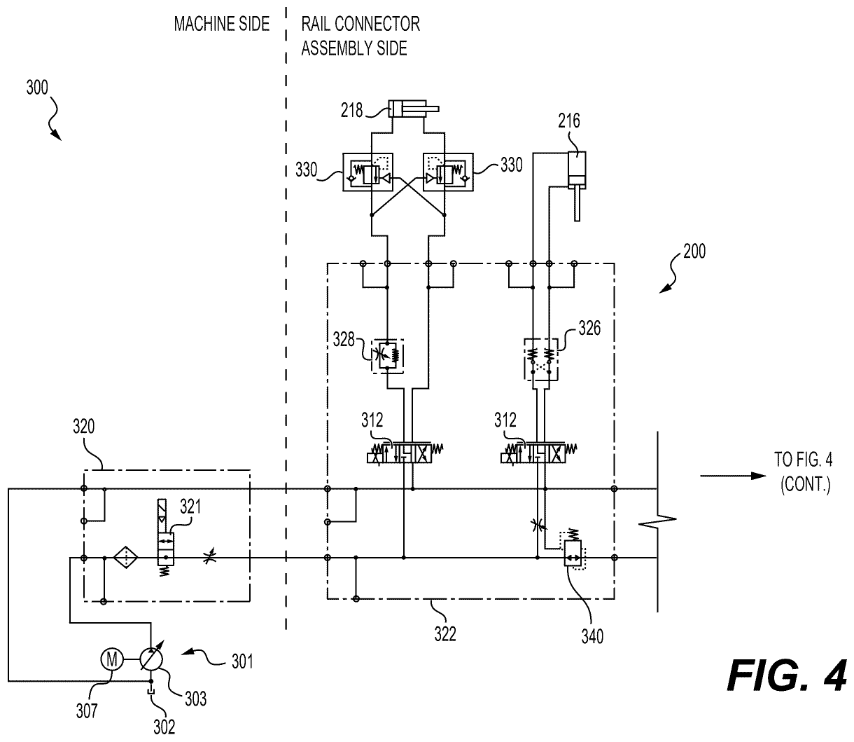

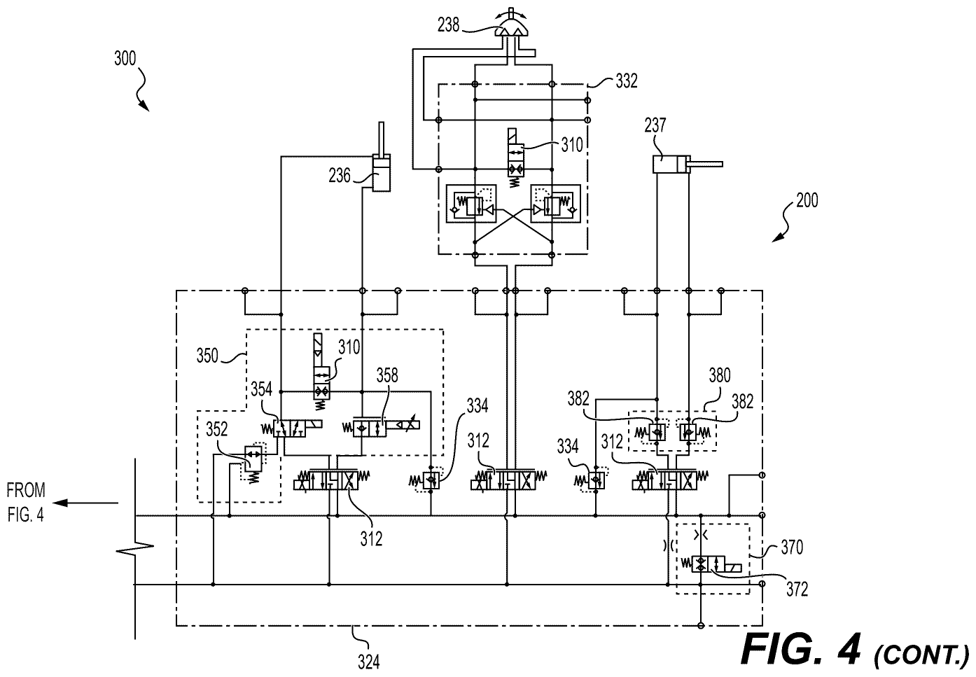

As will be discussed in FIG. 4 below, the boom valve manifold 322 may include a pressure reducing valve 340 or other appropriate element for reducing the pressure of the hydraulic fluid conveyed from the boom valve manifold 322 to the arm and contactor valve manifold 324. The hydraulic components associated with the upper trailing arm actuator 236, lower trailing arm actuator 237, and middle trailing arm actuator 238 do not require the high pressures for example that the boom actuator 218 may need. This reduced hydraulic pressure delivered to the arm and contactor valve manifold 324 allows the arm and contactor valve manifold 324 to be formed of a lighter weight material, such as aluminum. Based on the higher fluid pressures in the boom valve manifold 322, the boom valve manifold may be formed of a heavier weight material than the arm and contactor valve manifold 324, such as a ductile iron or steel material. Including two manifolds 322, 324 in boom assembly 210 requires only two hydraulic lines extending between the manifolds and along the length of the boom assembly 210. This helps to reduce the weight of the boom assembly 210 by not requiring the fluid lines for each of the arm assembly actuators (236, 237, 238) and contactor assembly 220 to extend the whole length of the boom assembly 210. Locating the arm and contactor valve manifold 324 at the distal end of the boom assembly 210 may also help avoid detrimental pressure drops. In addition, such a de-centralized valve manifold system may save space with the boom assembly 210.

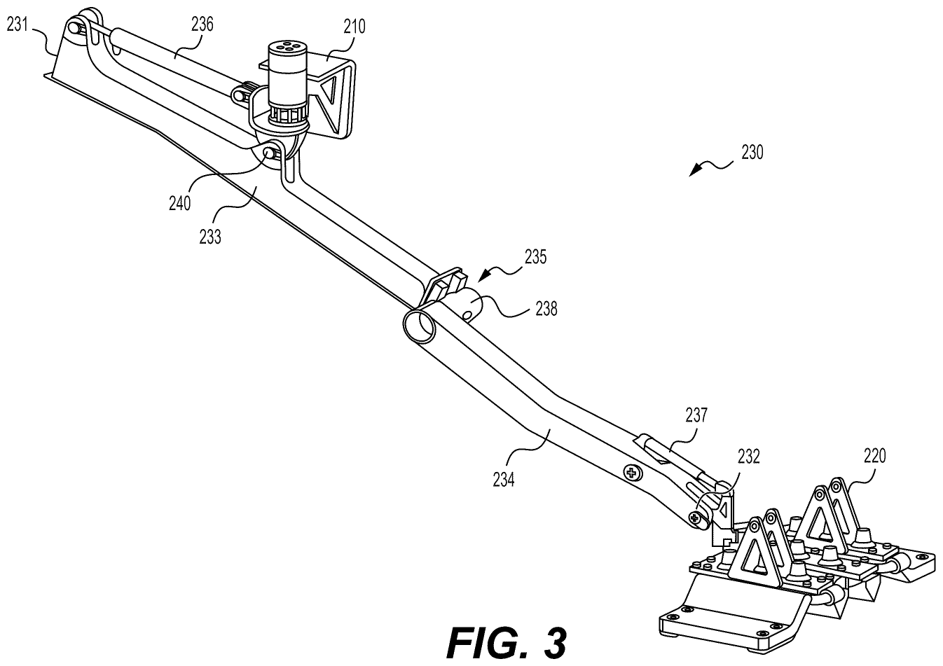

Referring to FIG. 3, the arm assembly 230 of rail connector assembly 200 forms a mechanical and electrical connection between the boom assembly 210 and contactor assembly 220, and may include a first or proximal end 231 connected to an end of the boom assembly 210 and a second or distal end 232 connected to the contactor assembly 220. The arm assembly 230 may be extendable and retractable and may have multiple degrees of freedom to allow for vertical and lateral pivoting about the boom assembly 210. In the exemplified embodiment, the arm assembly 230 may include two portions, an upper portion or arm 233 and a lower portion or arm 234, that are pivotally connected by a central joint 235. Also, upper arm 233 may include a pivot 240 where the upper arm 233 connects to boom assembly 210.

As noted above, the arm assembly 230 may include a plurality of hydraulic actuators 236, 237, 238 including one or more linear actuators and/or one or more rotary hydraulic actuators that move and position the arm assembly 230. For example, the upper trailing arm actuator 236 may be a liner actuator that controls vertical positioning of upper arm 233. Middle trailing arm actuator 238 may be a 180 degree rotary hydraulic actuator that is coupled between upper and lower arms 233 and 234 at central joint 235, and controls movement of the upper arm 233 vertically with respect to lower arm 234 between a collapsed position where the upper and lower arms 233 and 234 are folded against each other, to an extended or deployed position as shown in FIG. 3. Finally, lower trailing arm actuator 237 may include a linear actuator that controls the orientation of the contactor assembly 220, such as adjusting its pitch. As seen in FIG. 3, the upper trailing arm actuator 236 may be located at the first or proximal end 231 of the arm assembly 230 and the lower trailing arm actuator 237 may be located at the second or distal end 232 of the arm assembly 230.

Referring now to FIG. 4, the hydraulic system 300 controls various movements and functions within the rail connector assembly 200. For example, the hydraulic system 300 may extend and/or retract the boom assembly 210 outward from the mobile machine 140 about the pivot joint and along a generally horizontal direction. In addition, the hydraulic system 300 may extend and/or retract the arm assembly 230 and adjust the pitch of the contactor assembly 220.

As noted above, the hydraulic system 300 may generally include a hydraulic power unit (HPU) 301, the various hydraulic actuators (216, 218, 238, 236, 237) associated with rail connector assembly 200, and valve manifolds 320, 322, and 324 for controlling hydraulic fluid to and from the rail connector assembly 200 and the respective actuators. Also as noted above, hydraulic system 300 includes the HPU 301 located on the frame or body of the mobile machine 140 (the “machine side”), thus hydraulic and electrical lines or connections extend between the mobile machine 140 and the rail connector assembly 200. The electrical connections may provide power/current, and data/signal exchange between the mobile machine 140 and the rail connector assembly 200.

The hydraulic manifold 320 may include an on-off enable valve 321 that can prohibit flow of hydraulic fluid from HPU 310 to rail connector assembly 200, such as when the rail connector assembly is in a stowed position and not in use, or when sensors indicate a loss of hydraulic pressure in the hydraulic system 300 on the rail connector assembly 200 (e.g., potentially due to detachment of the rail connector system 200 from the mobile machine 140). On-off enable valve 321 may be a solenoid controlled valve and may be controlled based on one or more sensed conditions, such as low downstream pressures, and/or a movement of the boom lock actuator 216 to one or both of a locked condition and an unlocked condition. Hydraulic manifold 320 may also include an adjustable variable orifice to set the hydraulic flow pressure sent to rail connector assembly 200.

Turing to the components of hydraulic system 300 located on the boom assembly 210, both the boom valve manifold 322 and the arm and contactor valve manifold 324 may include flow control valves 312 associated with each of the hydraulic actuators, namely the boom actuator 218, boom lock actuator 216, upper trailing arm actuator 236, middle trailing arm actuator 238, and lower trailing arm actuator 237. The flow control valves 312 can include any appropriate configuration, such as the proportional, solenoid actuated 3-position, 4-way valves shown in FIG. 4, or alternatively a 3-position, 5-way valve with load sensing. One or more of the flow control valves 312 could also be an on-off type valve. For example, the flow control valve 312 associated with the boom lock actuator 216 may be an on-off type flow control valve.

The flow control valve 312 associated with boom actuator 218, may include on positions and an off position (valve position shown in FIG. 4) that is used when the boom actuator 218 is restricted from moving. Further, the hydraulic lines associated with boom actuator 218 may include an adjustable needle valve 328 that provides resistance to back pressure to assist in reducing valve chatter. In addition, the hydraulic lines associated with the boom actuator 218 may include counterbalance valves 330 that are configured to help prevent movement of the boom actuator 218 after a line failure. These counterbalance valves 330 provide for a limited hold of the boom actuator 218, whereas significant external forces acting on boom actuator 218 may open one of the counterbalance valves 330 to reduce the pressure in the boom actuator 218. In addition, these counterbalance valves 330 may be located directly adjacent to the boom actuator 218, and not within boom valve manifold 322, so as to help protect against undesired movement of the boom assembly 210 based on hydraulic line damage.

The flow control circuit associated with boom lock actuator 216 may include a pilot operated check valve arrangement 326 to lock the boom lock actuator 216 in place when the control valve 312 is in an off position as shown in FIG. 4. The pilot operated check valve arrangement 326 locks the boom lock actuator until the flow control valve 312 moved to an on position. In an on position, high pressure flowing to the boom lock actuator serves to open a check valve of the pilot operated check valve arrangement 326 to relieve one side of the boom lock actuator 216.

As noted above, boom valve manifold 322 may include a pressure regulation valve 340 that reduces the pressure of the hydraulic fluid sent to arm and contactor valve manifold 234. Pressure regulation valve 340 may take any conventional shape and may be adjustable.

Turning now to the arm and contactor valve manifold 324, the flow control circuit associated with the upper trailing arm actuator 236 may include a float and lift assist valve system 350. The float and lift assist system 350 may include a pressure regulation valve 352, a flow control valve 354, a float valve 310, and a proportional throttle valve 358. Pressure regulation valve 352 may be any appropriate regulation valve, and may be adjustable to control the pressure supplied through the pressure regulation valve 352 to the upper trailing arm actuator 236. Flow control valve 354 may be a solenoid controlled two-position valve, and may alternatively connect pressure regulation valve 352 or flow control valve 312 to the upper trailing arm actuator 236. Float valve 310 may be a solenoid operated two-position valve movable between a float position and a locked position. In the float position, the flow control valve 312 connects the two ends of the upper trailing arm actuator 236 together. Finally, proportional throttle valve 358 may move between two positions, where one position prohibits flow to the flow control valve 312 (the position shown in FIG. 4), and the second position allows flow to the flow control valve 312.

When the float and lift assist system 350 is activated, the flow control valve 354 allows a pressurized hydraulic fluid to both sides of the upper trailing arm actuator 236 via an open position of the float valve 310. The pressurized hydraulic fluid, however, is at a lower, predetermined pressure based on the setting of the pressure regulation valve 352. This controllable pressurized hydraulic fluid on both sides of the upper trailing arm actuator 236 serves to provide vertical assist due to the area differences on the different sides of the actuator piston. The proportional throttle valve 358 is closed during actuation of the float and lift assist system 350. Thus, the float and lift assist system 350 allows the upper trailing arm actuator 236 to float while providing a controllable vertical lift assist to the arm assembly 230 via the pressurized flow through the pressure regulation valve 352.

When the float and lift assist system 350 is not activated, the flow control valve 354 is connected to flow control valve 312, and the float valve 310 is in a closed position. The proportional throttle valve 358 may be moved to an open position to allow the upper trailing arm actuator 236 to lower a distal end of the upper arm 233 in a throttled manner.

The flow control circuit associated with the middle trailing arm actuator 238 may include a flow control valve 312, a counterbalance assembly 332 similar to that counterbalance valves 330, and a float valve 310. The float valve 310 may be actuated to allow the lower arm 234 of the arm assembly 230 to dangle during the deploying movement of the upper trailing arm assembly 233. It is noted that the counterbalance assembly 332 and the float valve 310 may be integrated into the middle trailing arm actuator 238 itself, rather than being provided as a separate arrangement within the arm and contactor manifold 324.

The flow control circuit associated with the lower trailing arm actuator 237 may include a flow control valve 312 and a makeup relief set 380 including a pair of makup valves 382. The makeup relief set 380 may provide hold and float functions for the lower trailing arm actuator 237, such that the contactor assembly 220 may stay in place, but move when acted upon by significant external forces acting on the trailing arm actuator 238.

Arm and contactor valve manifold 324 may include one or more safety protection valves 334 that are configured to open to avoid overpressurization of portions of hydraulic system 300. A thermal bleed system 370 may also be included in arm and contactor valve manifold 324. Thermal bleed system 370 may include an on-off, solenoid controlled valve 272 that provides a throttled recirculation of pressurized hydraulic flow to warm the components of the valve manifolds (320, 322, 324) prior to use in cold conditions.

### INDUSTRIAL APPLICABILITY

The disclosed aspects of the hydraulic system 300 can be used for deploying and controlling a rail connector assembly that provides current to a free-steering mobile machine with an electrically-conducting rail system on a worksite.

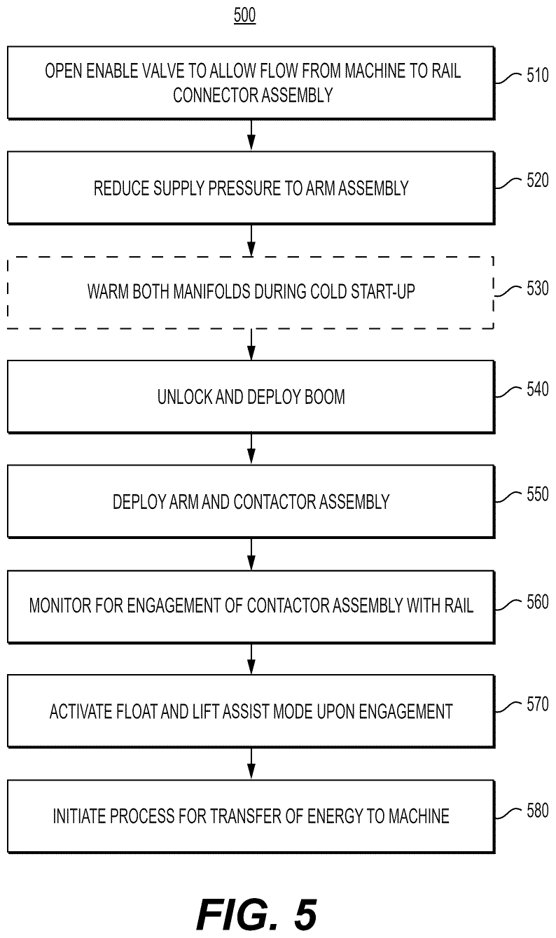

FIG. 5 is a flowchart illustrating an exemplary method 500 for operating a rail connector assembly 200 of a mobile machine power system 100 according to aspects of the present disclosure. Prior to the performance of method 500, the rail connector assembly 200 may be in a stowed and locked state against a side of the frame/body 150, such that boom assembly 210 extends generally parallel and adjacent the side of the mobile machine 140. Further, in this stowed and locked state, the arm assembly 230 may be positioned such that upper and lower arms 233 and 234 folded against one another and the contactor assembly is magnetically coupled to the frame/body 150 of mobile machine 140, as shown in FIG. 2.

Method 500 may include, for example a step 510 opening on-off enable valve 321 to allow flow from machine to rail connector assembly 200; reducing supply pressure to arm assembly 230 via pressure regulation valve 340 (step 520); optionally warming both manifolds during cold start-up situation at any time during the method 500 (step 530); opening boom lock control valve 312 to unlock and deploy boom assembly 210 (step 540); deploying arm and contactor assembly 230, 220 (step 550); monitor for engagement of contactor assembly with rail (step 560); activate float and lift assist of the upper trailing arm actuator 236 (step 570); and initiate process for transfer of energy to mobile machine 140 (step 580).

Regarding step 540, the unlocking and extending or deploying the boom assembly 210 from the stowed position against the mobile machine 140 to an extended or deployed position shown in FIG. 1 may be initiated upon a request to extend the rail connector assembly 200. The request to extend the rail connector assembly 200 may be a single request generated by an operator, for example, pushing a button in the operator cabin 160 or may be automatically generated based on a geographic location of the machine 140 as determined by a Global Navigation Satellite System (“GNSS”). In response to this request, the flow control valves 312 may be turned to an on position with respect to both the boom lock actuator 216 and the boom actuator 218, thus unlocking the boom assembly 210 and extending the boom assembly 210 away from the side of the mobile machine 140. The step 510 of unlocking and deploying boom assembly 210 may also include the actuation of the flow control valve 312 associated with the lower trailing arm actuator 237 to pivot contactor assembly 220 away from mobile machine 140 to magnetically decouple the contactor assembly 220 from the upper arm 133 of arm assembly 230. Once the boom is in the deployed position (FIG. 1), the control valve 312 associated with boom actuator 218 may be commanded to move to a hydraulic hold position as discussed above.

Concurrently with, or immediately after the unlocking and extending of boom assembly 210 to the deployed position in step 540, the arm assembly 230 and contactor assembly 220 may be moved the deployed position shown in FIGS. 1 and 2 (step 550). This may include actuation of the flow control valve 312 associated with the upper trailing arm actuator 236 to the on position to move the piston towards the cap end. This will cause the end 231 of the arm assembly 230 to raise, and the central joint 235 to lower vertically based on pivot 240. During this movement, the flow control valve 312 associated with middle arm assembly actuator 238 may be in the float condition and dangling as discussed above. When upper trailing arm actuator 236 has moved the upper arm 233 to the deployed position (FIGS. 1 and 3), lower trailing arm actuator 237 may be actuated to position the contactor assembly 220 to the deployed position, such as the position shown in FIG. 3. Finally, step 540 may include actuating, then holding the middle arm assembly actuator 238 so that the lower arm 234 extends farther away from upper arm 233 and provides the generally linear arrangement shown in FIG. 3.

With the arm assembly 230 in the deployed position as shown in FIG. 3, method 500 may monitor for when the contactor assembly 220 first contacts or engages with the rails 122 of the rails system 120 (step 630). This contact or engagement may be sensed in any appropriate manner, such as by pressure or position sensors associated with one or more of the trailing arm actuators 236, 237, 238, and/or one or more visual or proximity sensors. Upon sensing when the contactor assembly 220 contacts rails 122, hydraulic system 300 may activate the lift assist and float system 350 as described above. This lift and float mode helps to maintain contactor assembly 220 in contact with the rails 122 of the rail system 120 when the rail connector assembly 200 experiences vertical movements during travel. The lift assist helps to reduce the pressures on the conductor rails 120 by arm assembly 230 and contactor assembly 220.

Once the contactor assembly 220 is in contact or engagement with the rails 122, and the arm assembly 230 is in float mode, the rail connector assembly 200 can initiate a process for transferring energy from the rails 122 to the mobile machine 140 (step 580). Such a process can include various confirmations or checks before engaging the electrical conductor terminals of the contactor assembly 220 with the rail 122 and conveying current along the rail connector assembly 200 to one or more motors 144 or the battery system 146 of the mobile machine 140.

In accordance with the present disclosure, the hydraulic system 300 associated with the rail connector assembly 200 may provide assistance in maintaining contact between the arm assembly 230 and the rails 122 of the electricity-conducting rail system 120, even when the mobile machine 140 experiences undesired undulations.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A method for deploying a rail connector assembly of a mobile machine onto one or more conductor rails, the rail connector assembly including a boom assembly connected to a frame of the machine, an arm assembly connected to an end of the boom assembly, and a contactor assembly coupled to an end of the arm assembly, the method comprising:
deploying the boom assembly from a stowed condition to a deployed condition with at least one boom assembly hydraulic actuator;
deploying the arm assembly from a stowed condition to a deployed condition with at least one arm assembly hydraulic actuator; and
providing hydraulic assist to the at least one arm assembly hydraulic actuator, as a function of a contact relationship of the contactor assembly with one or more conductor rails.

2. The method of claim 1, further including placing the at least one arm assembly hydraulic actuator in a float condition as a function of a contact relationship of the contactor assembly with one or more conductor rails.

3. The method of claim 2, wherein the hydraulic assist is a lift assist of the arm assembly.

4. The method of claim 1, wherein the amount of lift assist is controllable.

5. The method of claim 1, wherein the hydraulic source pressure for the at least one boom assembly hydraulic actuator is greater than the hydraulic source pressure for the at least one arm assembly hydraulic actuator.

6. The method of claim 1, wherein the control of the at least one boom assembly hydraulic actuator is controlled at by a first manifold located in a proximal end of the boom assembly, and control of the at least one arm assembly hydraulic actuator is controlled at by a second manifold located in a distal end of the boom assembly.

7. The method of claim 6, further including reducing the hydraulic source pressure for the at least one arm assembly hydraulic actuator by a pressure-reducing valve located in the first manifold.

8. The method of claim 6, wherein the least one boom assembly hydraulic actuator and the at least one arm assembly hydraulic actuator are hydraulically driven by a common hydraulic power unit located on the body of the mobile machine.

9. The method of claim 1, wherein the contact relationship is initial engagement of the contactor assembly with the one or more conductor rails.

10. The method of claim 1, wherein the at least one arm assembly hydraulic actuator includes a first arm assembly hydraulic actuator and a second arm assembly hydraulic actuator, and the hydraulic assist is provided to the first arm assembly hydraulic actuator, and the second arm assembly hydraulic is permitted to float as a function of an external force applied to the contactor assembly.

11. The method of claim 1, further including disconnecting the supply of hydraulic drive fluid to the boom assembly and the arm assembly by a valve located on the body of the mobile machine.

12. The method of claim 1 further including actuating a thermal bleed system prior to the deploying of the boom assembly and the arm assembly.

13. A method for deploying a rail connector assembly of a mobile machine onto one or more conductor rails, the rail connector assembly including a boom assembly connected to a frame of the machine, an arm assembly connected to an end of the boom assembly, and a contactor assembly coupled to an end of the arm assembly, the method comprising:
deploying the boom assembly from a stowed condition to a deployed condition with at least one boom assembly hydraulic actuator;
deploying the arm assembly from a stowed condition to a deployed condition with at least one arm assembly hydraulic actuator; and
placing at least one arm assembly hydraulic actuator in a float condition and simultaneously providing hydraulic lift assist to the at least one arm assembly hydraulic actuator when the contactor assembly is riding on the one or more conductor rails.

14. The method of claim 13, wherein the amount of lift assist is controllable.

15. The method of claim 13, wherein a hydraulic source pressure for the at least one boom assembly hydraulic actuator is greater than a hydraulic source pressure for the at least one arm assembly hydraulic actuator.

16. The method of claim 13, wherein the at least one boom assembly hydraulic actuator is controlled at by a first manifold located in a proximal end of the boom assembly, and the at least one arm assembly hydraulic actuator is controlled at by a second manifold located in a distal end of the boom assembly.

17. The method of claim 16, further including reducing a hydraulic source pressure for the at least one arm assembly hydraulic actuator by a pressure-reducing valve located in the first manifold.

18. The method of claim 13, wherein the least one boom assembly hydraulic actuator and the at least one arm assembly hydraulic actuator are hydraulically driven by a common hydraulic power unit located on the body of the mobile machine.

19. A rail connector assembly for an electrically powered mobile machine, comprising:
a boom assembly with a first end and a second end;
an arm assembly movable between a stowed condition and a deployed condition, the arm assembly having a first end coupled to the boom, and a second end;
a contactor assembly coupled to the second end of the arm assembly; and
a hydraulic system including a float and lift assist valve system associated with the arm assembly.

20. The rail connector assembly of claim 19, wherein the float and lift assist valve system includes a pressure regulation valve, a flow control valve, and a float valve.
